(19) United States
(12) Patent Application Publication
(10) Pub. No.: US 2016/0169202 A1
(43) Pub. Date: Jun. 16, 2016

(54) SHORT-TERM OPERATION OPTIMIZATION METHOD OF ELECTRIC POWER SYSTEM INCLUDING LARGE-SCALE WIND POWER

(71) Applicants: STATE GRID CORPORATION OF CHINA, Beijing (CN); STATE GRID GANSU ELECTRIC POWER CORPORATION, Lanzhou, Gansu (CN); GANSU ELECTRIC POWR CORPORATION WIND POWER TECHNOLOGY CENTER, Lanzhou,Gansu (CN)

(72) Inventors: NINGBO WANG, LANZHOU, GANSU PROVINCE (CN); MING MA, LANZHOU, GANSU PROVINCE (CN); YANHONG MA, LANZHOU, GANSU PROVINCE (CN); GUANGTU LIU, LANZHOU, GANSU PROVINCE (CN); LONG ZHAO, LANZHOU, GANSU PROVINCE (CN); QIANG ZHOU, LANZHOU, GANSU PROVINCE (CN); DINGMEI WANG, LANZHOU, GANSU PROVINCE (CN); LIANG LU, LANZHOU, GANSU PROVINCE (CN); JIANMEI ZHANG, LANZHOU, GANSU PROVINCE (CN); QINGQUAN LV, LANZHOU, GANSU PROVINCE (CN)

(21) Appl. No.: 14/648,663

(22) PCT Filed: Apr. 2, 2014
(86) PCT No.: PCT/CN2014/000361

§ 371 Date: May 29, 2015

(30) Foreign Application Priority Data
May 3, 2013 (CN) 201310159947.2

(51) Int. Cl. F03D 9/00; F03D 7/00

(52) U.S. Cl. CPC F03D 9/003; F03D 7/00

(57) ABSTRACT

The present invention discloses a short-term operation optimization method for a power system including large-scale wind power, comprising modeling the randomness of wind power output, modeling the randomness of the load of electric power system and modeling net load of electric power system. Net load refers that for probability distribution of net load that is too discretized, probability distribution curve of net load is divided into N intervals, the probabilities for each interval are obtained and probability distribution curve of net load is obtained through calculating and weighing each interval. Through calculating randomness of power wind output and standard deviation of load prediction error of the electric power system, net load prediction error of the electric power system is obtained and reasonable coordination is made on the electric power system according to prediction error and prediction amount to better regulate the correlations between randomness, volatility, regionalism, double-circuit peak shaving and load of wind power generation, so as to realize optimization operation of the electric power system.

### TECHNICAL FIELD

The present invention refers to a short-term operation optimization method of an electric power system including large-scale wind power.

### BACKGROUND TECHNOLOGY

At present, when no wind power accesses to an electric power system, the instability of the electric power system is, to a large extent, caused by load fluctuations, and as load fluctuations change slowly and follow certain rules, it is easy to economically make dispatch between units. While after large-scale wind power gets access to a power grid, because of the random fluctuations of the wind power output, the volatility of equivalent load of an electric power system will increase and is hard to predict, so that a large-scale wind power grid connection has a higher requirement for short-term economic dispatch of an electric power system. Besides, as the output of the wind power plant is obviously intermittent and it fluctuates frequently and drastically with time, under extreme conditions, the wind power output rate even might jump among 0-100%, so that it is irregular, which will make power supply of the electric power system less reliable. At the same time, in order to maintain the balance between load and power generation of the electric power system at any time, other units in the electric power system frequently and rapidly regulates output. This will increase operating cost of the system. It shows that the large-scale wind power gets access to a power grid brings more new problems and challenges to the short-term economic dispatch and operation of an electric power system and it has stricter requirement for the operation of the conventional units in the system. On the other hand, limited by prediction technology, prediction accuracy of wind power output is not high and with increasing prediction time, the prediction error also increases constantly. Therefore, while generating power through making full use of wind energy resources, in order to ensure safe, economic and reliable operations of an electric power system, it is important to research short-term operation and optimization of an electric power system including large-scale wind power. In the economic dispatch model that has been built, while meeting various constraint conditions of an electric power system operation and unit operation, in order to coordinate reliability and economy of the power supply of a grid, new short-term economic dispatch mode with multi-time scale and multi-model is needed.

For short-term dispatch, wind power output data and load of each period need to be offered, an electric power system dispatching operation is made on the basis of the prediction of wind power. Researches show that for large-scale wind power grid connection, as a large amount of wind driven generators are geographically widespread, we can prove that the prediction error of the output of a wind power plant follows normal distribution with central-limit theorem. As large-scale wind power concentratedly gets access to a power grid, the prediction error of the wind power output that gets access to the electric power system can be considered as following a normal distribution. Similarly, the research indicates that prediction errors of both load and net load (equivalent load after taking wind power output from load) follow a normal distribution. On this basis, from net load, we can analyze the characteristics of a short-term optimization operation of an electric power system including large-scale wind power, but randomness of wind power output makes it impossible to operate an electric power system optimally.

### SUMMARY OF THE INVENTION

For the above issues, the present invention provides a short-term operation optimization method of an electric power system including large-scale wind power to better adjust the correlations between randomness, volatility, regionalism, double-circuit peak shaving and load of wind power generation, so as to realize optimization operation of the electric power system.

In order to realize the above purpose, the technical solution adopted in the present invention refers to:

a short-term operation optimization method of an electric power system including large-scale wind power, comprising the following steps:

modelling randomness of wind power output: as prediction error value of the wind power output follows zero-mean normal distribution, the relation between standard deviation of prediction error of the wind power output can be expressed as σ_{wt}=k_{w}×ŵₜ+k₀. In the formula, σ_{wt} is the predicted standard deviation of wind power; ŵₜ is the predicted value of wind power; k_{w} and k₀ refer to the prediction error constant; concluding wind power output according to the above predicted standard deviation of wind power, which can be expressed as wₜ=ŵₜ+θ_{wt}. In the formula, θ_{wt} is the random variable of the prediction error of wind power;

modelling randomness of the load of an electric power system: as load of the electric power system follows a normal distribution, the standard deviation of the prediction error of the load is in direct proportion to the predicted value of the load, their relation can be expressed as: σ_{dt}=k_{d}×\hat{d}ₜ. In this formula, σ_{dt} is the standard deviation of the prediction error random variable of the load; \hat{d}ₜ is the prediction value of the load; k_{d} is the prediction error coefficient of the load;

after modeling the above wind power output and load, modeling the net load of the electric power system. The net load refers to the difference after taking wind power output from load of the electric power system, relation of which can be expressed as: nₜ=dₜ−wₜ. As wind power output and load of electric power system are random variables of unrelated normal distribution, then net load follows a normal distribution and the standard deviation of its prediction error can be concluded from the following formula: σₙₜ=\sqrt{σ_{dt}²+σ_{wt}²}. Then probability distribution of net load can be obtained;

For over-discretization of the above probability distribution of the net load, the net load probability distribution curve can be divided into N intervals and the probabilities for each interval are obtained and probability distribution curve of the net load can be obtained through calculating and weighing each interval.

Pursuant to preferred optimal implementation embodiments of the present invention, rational distribution on wind power and thermal power units in electric power system are made according to the above probability distribution curve of net load:

Step 1: based on statistical analysis of historical data of wind power, obtaining predicted data of wind power output and prediction error value of wind power output for the future 24 hours according to current prediction mode of wind power output;

Step 2: considering wind power output as negative load, obtaining the net load curve for one day after overlaying with load; based on net load curve, determining startup and shutdown periods of the thermal power unit for one day;

Step 3: determining startup and shutdown periods of the thermal power unit for one day and obtaining seven representative plans according to the above net load probability distribution curve;

Step 4: for each plan, dispatching the distribution of net load in each thermal power unit;

Step 5: analyzing dispatching results and obtaining the planned expected value with weighted summation of the results of each plan; and

Step 6: correcting the unit output plan of next period according to the prediction value of the wind power output and the prediction error value of the wind power output.

Technical solution of the present invention is of the following beneficial effects:

For the technical solution of the present invention, through calculating the randomness of the power wind output and the standard deviation of load prediction error of the electric power system, the net load prediction error of the electric power system is obtained and reasonable coordination is made on the electric power system according to the prediction error and prediction amount to better regulate the correlations between randomness, volatility, regionalism, double-circuit peak shaving and load of wind power generation, so as to realize optimization operation of the electric power system.

With reference to the drawings and embodiments, technical solution of the present invention will be further illustrated in details below.

### BRIEF DESCRIPTION OF THE DRAWINGS

FIG. 1 is a prediction error distribution probability graph of the wind power output illustrated in the embodiment of the present invention;

FIG. 2 is a flow chart of rational distribution made on the wind power and thermal power units in an electric power system according to net load probability distribution curve.

### EMBODIMENTS OF THE PRESENT INVENTION

With reference to the drawings, the preferred embodiments of the present invention are illustrated below. It should be noted that the following preferred embodiments are only used to illustrate and explain the present invention, but not to limit the scope of the present invention.

A short-term operation optimization method for an electric power system including large-scale wind power, comprising the following steps:

modelling randomness of wind power output: as the prediction error value of the wind power output follows a zero-mean normal distribution, the relation between standard deviation of the prediction error of the wind power output can be expressed as σ_{wt}=k_{w}×ŵₜ+k₀, wherein σ_{wt} is the predicted standard deviation of the wind power; ŵₜ is the predicted value of the wind power; k_{w} and k₀ refer to the prediction error constant;

calculating the wind power output according to the above predicted standard deviation of the wind power, which can be expressed as wₜ=ŵₜ+θ_{wt}, wherein, θ_{wt} is the random variable of the prediction error of the wind power;

modelling randomness of the load of the electric power system: as the load of the electric power system follows a normal distribution, the standard deviation of the prediction error of the load is in direct proportion to the predicted value of the load, their relation can be expressed as: σ_{dt}=k_{d}×\hat{d}ₜ, wherein, σ_{dt} is the standard deviation of the prediction error random variable of the load; a \hat{d}ₜ is the prediction value of the load; k_{d} is the prediction error coefficient of the load;

after modeling the above wind power output and load, modelling net load of the electric power system, wherein the net load refers to the load value after taking wind power output from the load of the electric power system, relation of which can be expressed as: nₜ=dₜ−wₜ. As the wind power output and the load of the electric power system are random variables of unrelated normal distribution, then net load follows a normal distribution and the standard deviation of its prediction error can be concluded from the following formula: σₙₜ=\sqrt{σ_{dt}²+σ_{wt}²}. Then probability distribution of net load can be obtained;

For over-discretization of the above probability distribution of net load, net load probability distribution curve can be divided into N intervals and the probabilities for each interval are obtained and probability distribution curve of net load can be obtained through calculating and weighing each interval.

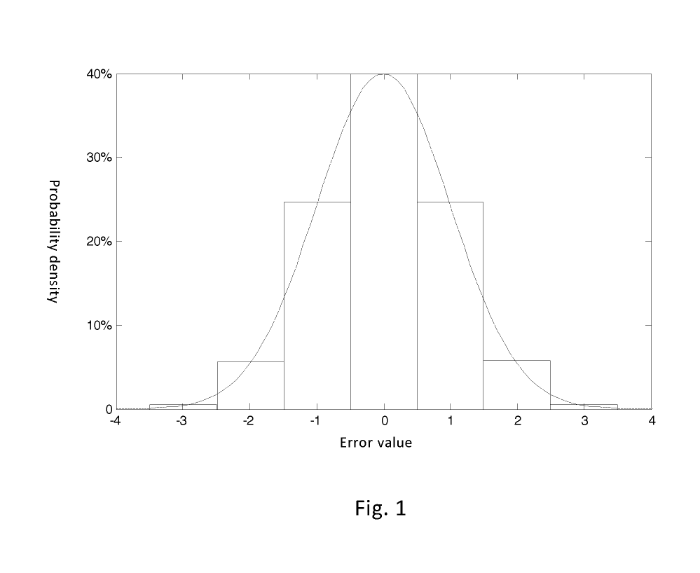

As shown in FIG. 1, during discretization, the value of the net load within a certain range will be represented by a selected value to match probability of this range to obtain limited representative points so as to simplify calculation. According to probability characteristic of a normal distribution, the probability that prediction error is distributed within the three positive and negative standard deviations can reach 99.95% and the probability that prediction error is distributed beyond the three standard deviations is very small, which can be considered as zero. Thus, only the range between the three positive and negative standard deviations needs to be considered to make a seven-point discretization, so as to equate the prediction error value of the wind power output within this range with the median in the range of one standard deviation.

Because the wind power output has strong volatility, at present, the accuracy for the wind power output prediction model to predict the wind power output is still low. If it needs to meet the electric power balances under all the wind power output conditions, a large amount of spinning reserves should be added, which may generate very high operating cost, so as to reduce the economic efficiency of the electric power system. On the other hand, because there is a very small chance that the actual output of the wind power deviate from predicted value greatly, it is to balance between security and economy properly while making economic dispatching decision for the electric power system that includes large-scale wind power.

In order to ensure security and stability of an electric power system and guarantee its economy at the same time, on the basis of predicted output of wind power, within predicted fluctuation range of the wind power, properly increasing the thermal power units to reserve a part for spinning reserve so as to offset the deviation between actual output and predicted output of the wind power.

When the wind power output seriously deviates from the predicted value and the reserved spinning reserve of the thermal power unit cannot offset the change between the actual output and the predicted output of wind power, corresponding measures should be taken to ensure the system operates safely and stably. When actual output of wind power is much higher than predicted output, the thermal power unit needs to lower the output correspondingly to guarantee electric quantity balance, and when it reaches the lower limit and the unit cannot lower any more, in order to guarantee security of the electric power system, wind curtailment needs to be taken. When actual output of wind power is much lower than the predicted output, thermal power unit needs to raise the output correspondingly to make up for insufficient electric quantity caused by insufficient power end, and when it reaches the upper limit and the thermal power unit cannot raise output any more, in order to prevent the stability of the electric power system from being broken for imbalance of power, a part of the load needs to be cut off to guarantee the stability of the electric power system.

The short-term optimization operation of the electric power system including wind power is to consider randomness and volatility of wind power output, while ensuring reliable power supply and meeting system security and technological constraints of units, minimize the sum of fuel consumption and lost load punishment of the thermal power unit in a wind power grid connection system within the cycle of operation.

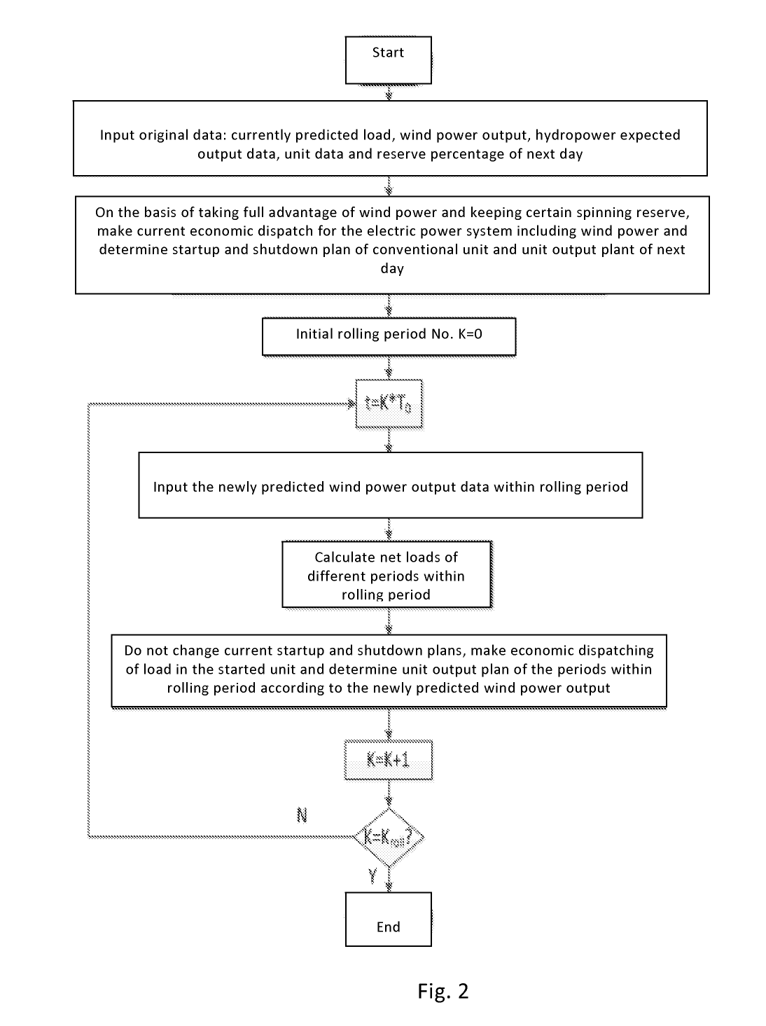

As shown in FIG. 2, making rational distribution on wind power and thermal power units in an electric power system according to the net load probability distribution curve. In FIG. 2, “Kroll” refers to the total number of times for spinning and dispatching required in a day.

Step 1: based on statistical analysis of historical data of wind power, obtaining predicted data of wind power output for the future 24 hours and prediction error value of wind power output according to current prediction mode of wind power output;

Step 2: considering wind power output as negative load, obtaining the net load curve for one day after overlaying with load; based on net load curve, determining startup and shutdown periods of the thermal power unit for one day;

Step 3: determining startup and shutdown periods of the thermal power unit for one day and completing seven representative plans according to the above net load probability distribution curve (considering the range between the three positive and negative standard deviations, making seven-point discretization, so as to be equivalent to the prediction error value of wind power output within this range with the median in the range of one standard deviation and these seven-point discretization is regarded as representative value);

Step 4: for each plan, dispatching the distribution of net load in each thermal power unit;

Step 5: analyzing dispatching results and obtaining the planned expected value with weighted summation of the results of each plan;

Step 6: correcting the unit output plan of next period according to predicted value of wind power output and prediction error value of wind power output.

What needs to be noted in the end is that: what is said above is only the preferred embodiments of the present invention but is not confined to the scope of the present invention. Although the present invention has been illustrated in details referring to the above embodiments, a person of ordinary skill in the art can modify the technical solution recorded in the above embodiments or replace part of its technological characteristics. Any modification, replacement and improvement made based on the spirit and principle of the present invention should be within the protections cope of the present invention.

1. A short-term operation optimization method of an electric power system including large-scale wind power characterized in that, the method comprising the following steps:
modelling randomness of wind power output: as prediction error value of wind power output follows a zero-mean normal distribution, relation between standard deviation of prediction error of wind power output is expressed as σ_{wt}=k_{w}×ŵₜ+k₀, wherein, σ_{wt} is predicted standard deviation of wind power; ŵₜ is predicted value of wind power; k_{w} and k₀ refer to prediction error constant;
calculating the wind power output according to the above predicted standard deviation of wind power, which is expressed as wₜ=ŵₜ+θ_{wt}, wherein, θ_{wt} is random variable of prediction error of wind power;
modeling randomness of the load of the electric power system: as load of the electric power system follows a normal distribution, standard deviation of prediction error of the load is in direct proportion to predicted value of the load, their relation is expressed as: σ_{dt}=k_{d}×\hat{d}ₜ, wherein, σ_{dt} is standard deviation of prediction error random variable of the load; \hat{d}eₜ is prediction value of the load; k_{d} is prediction error coefficient of the load;
after modeling the above wind power output and the load, modeling net load of the electric power system, net load refers to the remaining load when wind power output is taken out from the load of the electric power system, relation of which is expressed as: nₜ=dₜ−wₜ, as wind power output and load of the electric power system are random variables of unrelated normal distribution, then net load follows normal distribution, standard deviation of the net load's prediction error is concluded from the following formula: σₙₜ=\sqrt{σ_{dt}²+σ_{wt}²}, probability distribution of the net load is obtained;
over-discretizing the probability distribution of the net load, wherein a net load probability distribution curve is divided into N intervals and the probabilities for each interval are obtained and probability distribution curve of net load is obtained through calculating and weighing each interval.

2. The short-term operation optimization method of an electric power system including large-scale wind power according to claim 1 characterized in that a rational distribution is made on wind power and thermal power units in the electric power system according to the above probability distribution curve of the net load in the following steps:
step 1: based on statistical analysis of historical data of wind power, obtaining predicted data of wind power output for future 24 hours and obtaining prediction error value of wind power output according to current prediction mode of wind power output;
step 2: considering wind power output as negative load, obtaining the net load curve for one day after overlaying with the load; based on the net load curve, determining startup and shutdown periods of the thermal power unit for one day;
step 3: determining startup and shutdown periods of the thermal power unit for one day and completing seven representative plans according to the above net load probability distribution curve;
step 4: for each plan, dispatching the distribution of the net load in each thermal power unit;
step 5: analyzing dispatching results and obtaining the planned expected value with weighted summation of the results of each plan;
step 6: correcting the unit output plan of next period according to prediction value of the wind power output and the prediction error value of wind power output.
